(19) United States
(12) Patent Application Publication
(10) Pub. No.: US 2013/0304578 A1
(43) Pub. Date: Nov. 14, 2013

(54) METHOD AND APPARATUS FOR ENHANCED IN-STORE RETAIL EXPERIENCE USING LOCATION AWARENESS

(71) Applicant: 24/7 CUSTOMER, INC., Campbell, CA (US)

(72) Inventors: Pallipuram V. Kannan, Los Gatos, CA (US); Trey Lindseth, Oakland, CA (US); Gangadharan Kumar, Bangalore (IN)

(73) Assignee: 24/7 CUSTOMER, INC., Campbell, CA (US)

(21) Appl. No.: 13/868,945

(22) Filed: Apr. 23, 2013

Related U.S. Application Data
(60) Provisional application No. 61/644,341, filed on May 8, 2012.

(51) Int. Cl. G06Q 30/02

(52) U.S. Cl. CPC G06Q 30/0261
USPC 705/14.54; 705/14.58

(57) ABSTRACT

Embodiments of the invention provide a nexus between a user's presence within or proximate to a brick and mortar store outside of an explicit user transaction within the store, that is based solely upon the user's presence within the store, and not on any affirmative actions taken by the user by maintaining location awareness of the user and by communicating this awareness in real time, as the user moves from location to location, to brick and mortar stores at or near to the user's location. In this way, embodiments of the invention link the user's virtual presence, for example via the Internet, and all of the user-related information that is available for data mining, for example using big data techniques, to the user's physical presence at a physical location to create an enhanced user experience within the physical location in real time.

### CROSS REFERENCE TO RELATED APPLICATIONS

This application claims priority to U.S. provisional patent application Ser. No. 61/644,341, filed May 8, 2012, which application is incorporated herein in its entirety by this reference thereto.

### BACKGROUND OF THE INVENTION

1. Technical Field

The invention relates to the customer experience. More particularly, the invention relates to a method and apparatus that uses location awareness to provide an enhanced in-store retail experience for customers.

2. Description of the Background Art

In information technology, big data is a collection of data sets so large and complex that it becomes difficult to process using on-hand database management tools or traditional data processing applications. The challenges include capture, curation, storage, search, sharing, analysis, and visualization. The trend to larger data sets is due to the additional information derivable from analysis of a single large set of related data, as compared to separate smaller sets with the same total amount of data, allowing correlations to be found to spot business trends, determine quality of research, prevent diseases, link legal citations, combat crime, and determine real-time roadway traffic conditions.

While on-line commerce is now well established, and big data is beginning to become an important factor in personalizing user experiences across a range of on-line activities, the brick and mortar world remains unaware of all user information except for, perhaps during the execution of sales transactions, when stored user profiles linked to the user's identity may be used for authentication and, perhaps, to offer point of sales incentives.

A promising new technology that is finding increasing use in the brick and mortar world is near field communication (NFC), which is a set of standards for smartphones and similar devices to establish radio communication with each other by touching them together or bringing them into close proximity, usually no more than a few centimeters. Present and anticipated applications include contactless transactions, data exchange, and simplified setup of more complex communications, such as Wi-Fi. Communication is also possible between an NFC device and an unpowered NFC chip, called a tag.

Thus, a user can enter a brick and mortar store and make a purchase without presenting a credit card, for example using NFC features of a cell phone. Because the transaction is entirely electronic, much can be learned about the user at the time of the transaction from what is already known about the user. Even so, given the insights about the user that could be offered, for example, by mining user information using the big data tools mentioned above, such transactions typically concern no more than authenticating the user and completing a sale.

### SUMMARY OF THE INVENTION

Embodiments of the invention provide a nexus between a user's presence within, in proximity to, or movement toward a brick and mortar store outside of an explicit user transaction within the store, that is based solely upon the user's presence within the store, and not on any affirmative actions taken by the user. A presently preferred embodiment, with user permission as required, maintains location awareness of the user, for example via geo-location of a device within the user's possession, such as a smart phone, and communicates this awareness to the herein disclosed system in real time, as the user moves from location to location, which in turn communicates this information to brick and mortar stores and other such physical establishments at or near to the user's location. In this way, embodiments of the invention link the user's virtual presence, for example via the Internet, and all of the user-related information that is available for data mining, for example using big data techniques, to the user's physical presence at a physical location to create an enhanced user experience within the physical location in real time.

### BRIEF DESCRIPTION OF THE DRAWINGS

FIG. 1 is a block schematic diagram that shows the use of location awareness to provide an enhanced in-store retail experience for customers according to the invention;

FIG. 2 is a block schematic diagram showing a user profile as applied to the use of location awareness to provide an enhanced in-store retail experience for customers according to the invention;

FIG. 3 is a flow diagram showing the use of location awareness to provide an enhanced in-store retail experience for customers according to the invention;

FIG. 4 is a block schematic diagram that illustrates the data flow used to determine an individual's proximity to a retail store location according to the invention; and

FIG. 5 is a block schematic diagram that depicts a machine in the exemplary form of a computer system within which a set of instructions for causing the machine to perform any of the herein disclosed methodologies may be executed.

### DETAILED DESCRIPTION OF THE INVENTION

Embodiments of the invention provide a nexus between a user's presence within, in proximity to, or movement toward a brick and mortar store outside of an explicit user transaction within the store, that is based solely upon the user's presence within the store, and not on any affirmative actions taken by the user. A presently preferred embodiment, with user permission as required, maintains location awareness of the user, for example via geo-location of a device within the user's possession, such as a smart phone, and communicates this awareness to the herein disclosed system in real time, as the user moves from location to location, which in turn communicates this information to brick and mortar stores and other such physical establishments at or near to the user's location. In this way, embodiments of the invention link the user's virtual presence, for example via the Internet, and all of the user-related information that is available for data mining, for example using big data techniques, to the user's physical presence at a physical location to create an enhanced user experience within the physical location in real time.

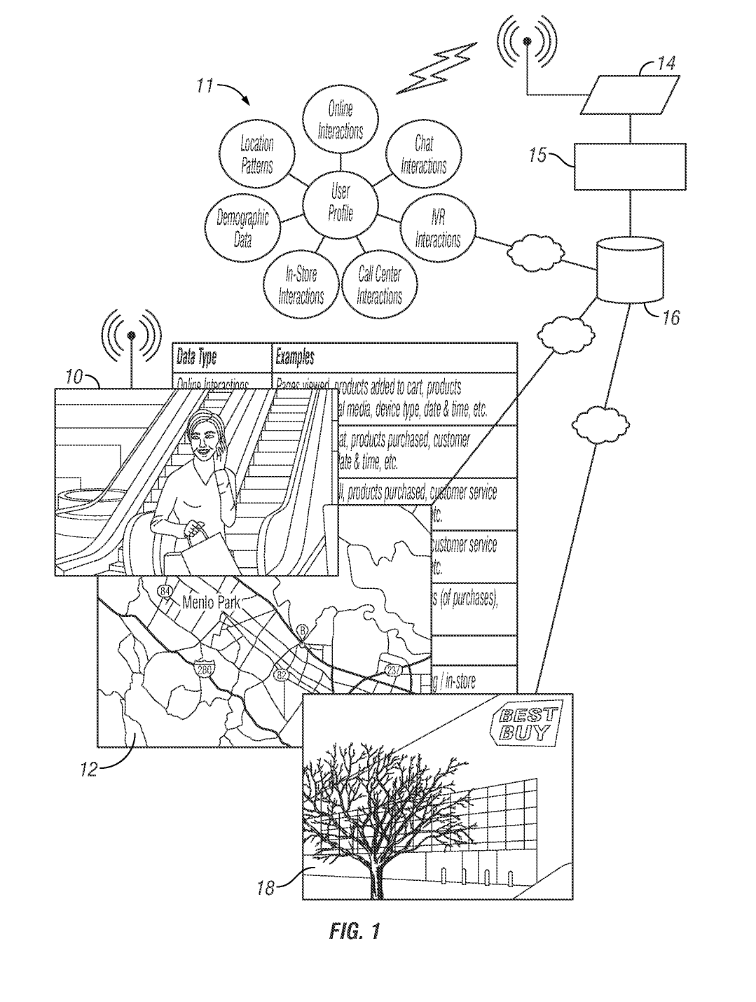

FIG. 1 is a block schematic diagram showing a user 10 in a store, for example, a mall or department store. While the invention is described herein in connection with a presently preferred embodiment that relates to retail sales locations, those skilled in the art will appreciate that the invention is readily applicable to other physical locations which may include, for example and not by way of limitation, service offices, such as insurance or medical facilities, entertainment venues, such as gyms and movie theaters, etc.

The user has a wireless device, such as a smartphone, but which could be any wireless device that can be passively interrogated or that passively identifies the user's location, such as a GPS, GPRS, EDGE, 3G, 4G, LTE, NFC device, RFID device, Bluetooth device, etc.

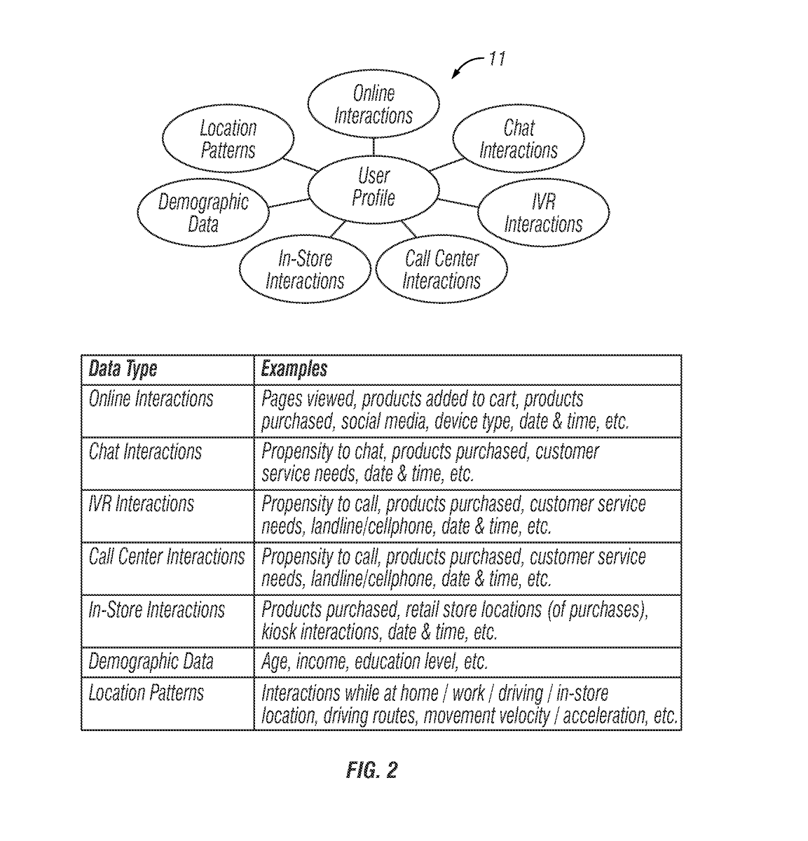

An on-line profile 11 is associated with the user, which contains information about the user's Web browsing habits, demographic information, Web journeys at one or more websites, and the like. A user profile is a set of personal data associated with a specific user. A profile refers therefore to the explicit digital representation of a person's identity. A user profile can also be considered as the computer representation of a user model. A profile can be used to store the description of the characteristics of a person. This information can be exploited by systems taking into account the persons' characteristics and preferences. Profiling is the process that refers to construction of a profile via the extraction from a set of data. User profiles can be found on operating systems, computer programs, recommender systems, or dynamic websites (such as online social networking sites or bulletin boards). An example a user profile is shown in FIG. 2.

Through a big data platform, data pertaining to an individual's interactions across channels, e.g. websites, call centers, in-store, can be stitched together to provide a holistic view of that individual's preferences and behavior patterns. Certain data elements can be used to link interaction data across channels, for example the individual's telephone number, email address, etc.

Although the user is not actively using the wireless device as part of the shopping experience, the device is active and, as such, the location of the device is known through use of geolocation techniques. Geolocation is the identification of the real-world geographic location of an object, such as mobile phone, or an Internet-connected computer terminal. Geolocation may refer to the practice of assessing the location, or to the actual assessed location. Geolocation is closely related to the use of positioning systems, but can be distinguished from it by a greater emphasis on determining a meaningful location, e.g. a street address, rather than just a set of geographic coordinates. In addition to the physical location, other attributes, such as direction of motion, velocity, acceleration, etc. are also considered part of the geolocation and can be used to customize an in-store retail experience. In FIG. 1, the user's location 12 is identified.

For either geolocating or positioning, the locating engine often uses radio frequency (RF) location methods, for example Time Difference Of Arrival (TDOA) for precision. TDOA systems often use mapping displays or other geographic information system. This is in contrast to earlier radiolocation technologies, for example Direction Finding where a line of bearing to a transmitter is achieved as part of the process. Internet and computer geolocation can be performed by associating a geographic location with the Internet Protocol (IP) address, MAC address, RFID, hardware embedded article/production number, embedded software number, such as UUID, Exif/IPTC/XMP or modern steganography, invoice, Wi-Fi positioning system, or device GPS coordinates, or other, perhaps self-disclosed information.

Geolocation usually works by automatically looking up an IP address on a WHOIS service and retrieving the registrant's physical address. IP address location data can include information such as country, region, city, postal/zip code, latitude, longitude and time zone. Deeper data sets can determine other parameters, such as domain name, connection speed, ISP, language, proxies, company name, US DMA/MSA, NAICS codes, and home/business. With mobile devices, the geolocation can be determined from the GPS coordinates, WiFi coordinates, and/or cell tower triangulation of the device itself. This geolocation information, along with the device ID, such as a UUID, is available to applications running on the mobile device. These applications can transmit the geolocation and device ID over the data network to a big data platform. Backend servers can then compare the geolocation information from the mobile device against retail store location coordinates to determine proximity to the store and whether the device is moving toward or away from the store location.

In embodiments of the invention, the user's geolocation is used to determine the user's proximity to one or more stores or other physical establishments 18. An embodiment of the invention receives user presence information as an input 14. This information is combined at a processor 15, such as a computer or other data processing element, with the user's geolocation, profile, and other information within or available to, e.g. via the Internet, a database 16, to identify stores and other establishments that are near to the user's location or at which the user is located.

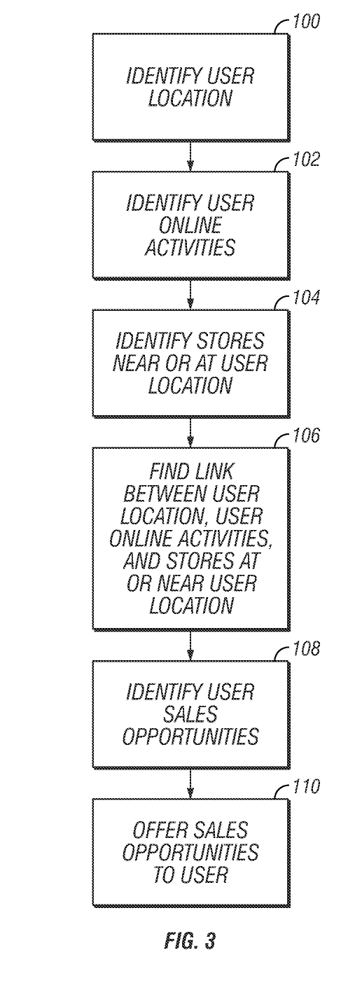

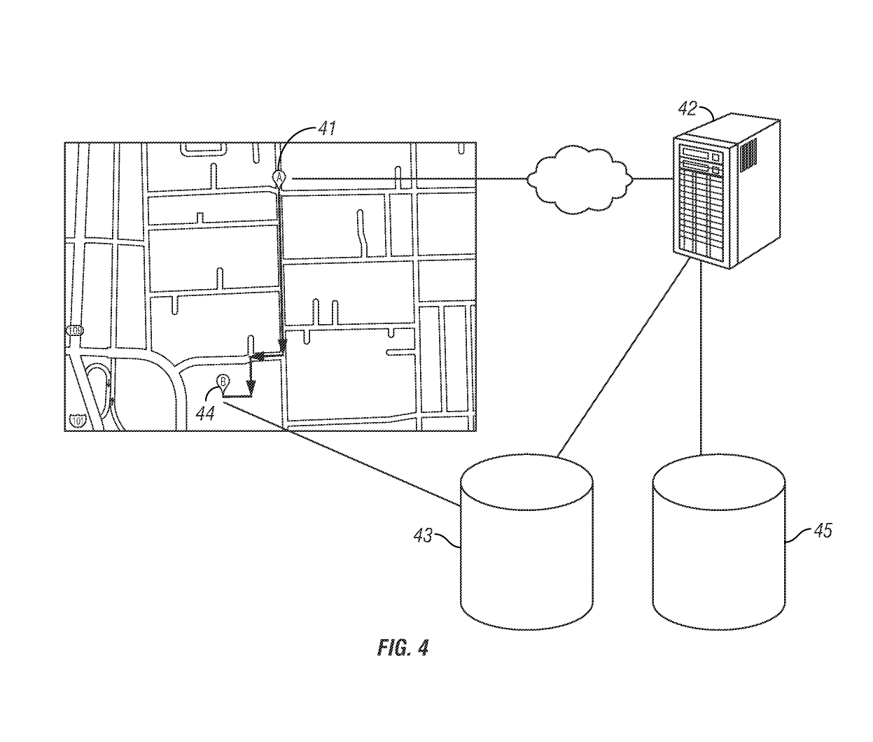

FIG. 3 is a flow diagram showing the use of location awareness to provide an enhanced in-store retail experience for customers according to the invention. The user's location is identified (100) and online activities and/or other profile information related to the user is then identified (102). FIG. 4 is a block schematic diagram that illustrates the data flow used to determine an individual's proximity to a retail store location according to the invention. An application on the mobile device transmits geolocation information 41 to an application server 42. This geolocation information can include the GPS coordinates of the mobile device, along with the direction of movement and velocity which can be obtained from the device's built-in accelerometer. The application server then uses a backend database 43 to look up nearby retail store locations 44. Using the device ID, the application server identifies the corresponding user profile in the big data platform 45 and retrieves relevant interaction data associated with the individual across all interaction channels. The user's location information is then used to identify stores or other physical establishments at or near the user's location (104). These locations may be part of a commerce network that subscribes to a service which is provided in accordance with the invention, they may be provided based upon a user subscription to a service based upon the invention, or they may be provided without a preexisting commitment on the part of either a merchant or the user.

A nexus between the user location, the user's online or other activities, and stores at or near the user's location is found (106). Based upon this nexus, sales or other opportunities for the user are identified (108) and offered to the user (110). Offers can be presented to the user via a number of mechanisms including, but not limited to, mobile device application alerts, SMS, email, and a phone call using an outbound dialer.

An aspect of the invention is similar to, but significantly distinct from the use of geotargeting in geomarketing and Internet marketing, which is a method of determining the geolocation of a website visitor and delivering different content to that visitor based on the visitor's location, such as country, region/state, city, metro code/zip code, organization, IP address, ISP or other criteria. A common usage of geotargeting is found in online advertising, as well as Internet television with sites, such as iPlayer and Hulu which may restrict content to those geolocated in specific countries.

In contrast thereto, an embodiment of the invention tries to find a connection between the user's present location and the user's online activities, especially in connection with online commerce, as well as interactions across other channels including IVRs, call centers, and online chat platforms, and then identifies stores or other establishments at or near to the user's location that have a linking connection with the user. For example, if the user was recently shopping for tires online, but did not make a purchase, then the user may be presented with an opportunity, for example by a text message, to purchase tires when the user is visiting a store that has a tire department, such as Wal-Mart or Costco, or a sales person in the store may be alerted of the customer's presence and approach the customer with a special sales offer.

A key aspect of the invention is the fact that the user was not specifically looking for tires at this store, for example the user may have been buying groceries, but the user location information and online activities provided a basis for identifying the opportunity to offer tires to the user. This action is entirely passive and takes place in real time while the user is moving from location to location. Thus, unlike geotargeting, which takes place while the user is actively browsing the Internet from a fixed location, the invention makes use of the coincidence between the user's presence at a location and a connection between the location and the user's past online behavior.

It is important to note that, in many cases, the invention may require user permission due to concerns regarding user privacy. Internet privacy involves the right or mandate of personal privacy concerning the storing, repurposing, providing to third-parties, and displaying of information pertaining to oneself via the Internet. Privacy can entail either Personally Identifying Information (PII) or non-PII information, such as a site visitor's behavior on a website. PII refers to any information that can be used to identify an individual. For example, age and physical address alone could identify who an individual is without explicitly disclosing their name, as these two factors are unique enough to typically identify a specific person. Thus, because at least some user information is required, it is thought that the protection of user privacy may require user assent before some embodiments of the invention may implemented in connection with any specific user.

Use cases of the herein disclosed invention include, but are not limited to:
Linking previous user interactions with a business, such as previous purchase history, products viewed online but not purchased, social media posts, etc., and current location awareness to notify and/or alert a user, e.g. via mobile device application alerts, SMS, email, or a phone call, of the location of products of interest, e.g. products that the user previously searched for online but did not purchase, when the user's location coincides with the store location.
Linking online and/or phone purchases and current location awareness to offer related and/or complementary products proactively when the user enters a store for in-store pickup of online purchases.
Linking previous customer service requests, e.g. warrantee inquiry, and current location awareness to offer related and/or complementary products proactively when a user drives near a retail store.
For cross-sell scenarios, automatically determine relevant items not currently available in the store and proactively offer a purchase option and optimal delivery channel to the user based on the user's preferences. The offer can be delivered at checkout or after checkout, e.g. given the velocity of movement of the mobile device, determine the user is walking to his car in the parking lot and send an offer before he starts the car and drives away.
Linking previous user interactions and/or online and/or phone purchases and current location awareness to notify and/or alert the user proactively when inventory is available in a nearby store.
Scanning QR and/or UPC codes using the individual's mobile device, not a computer or system associated with the retail establishment, in the store to get product information and comparisons, and to purchase online with a mobile device, where the product is delivered via a preferred method, e.g. in-store pickup at a current or alternate store or shipped to an address on file. In this case, the user takes a picture of the QR/UPC code using a mobile device. Based on the geolocation of the device, it is proactively known which store the user is in, and the system can provide relevant product information, e.g. that the location does not have inventory but a nearby store does, all without the customer interacting with a store employee.
Linking previous user interactions with a business and current location awareness to merge an online and/or virtual shopping cart with physical items at an in-store checkout.
Linking online and/or phone purchases and current location awareness to notify the store proactively of customer proximity to initiate the picking process, e.g. when the customer enters parking lot, the stock room is notified and assembles purchased products for customer pickup.

### Computer Implementation

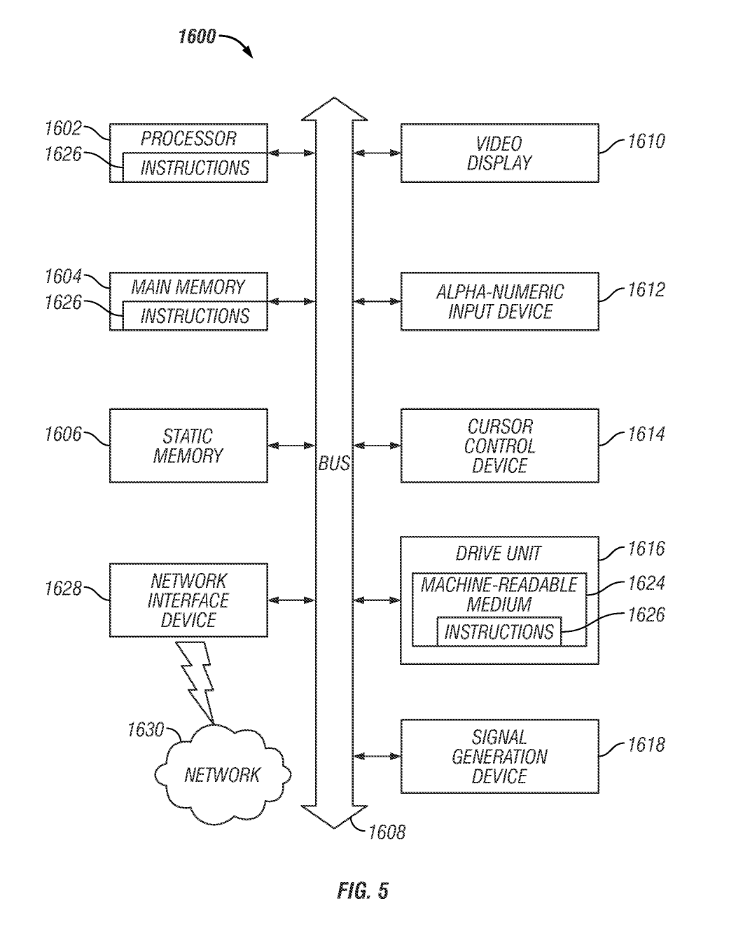

FIG. 5 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising:
a processor receiving and maintaining awareness of a user's physical location and maintaining said location awareness in real time, as said user moves from location to location;
said processor using said location awareness to discover a nexus between said user's presence within, proximity to, or movement toward one or more physical facilities outside of an explicit user transaction within any of said facilities, wherein said nexus is further discovered by said processor accessing user-related profile information and matching said user-related information to facility-related information, said nexus comprising a coincidence of said user location, said user information, said facility location, and one or more characteristics of said facility that bears a relevant connection with said user-related profile information; and
said processor using said nexus of said user-related information and said facility-related information to create an enhanced user experience within or in connection with said one or more facilities in real time.

2. The method of claim 1, wherein said profile information comprises any of said user's interactions across one or more communication channels with said facility.

3. The method of claim 2, wherein said communications channels comprising any of online, online chat, email, social media, IVR, and call center.

4. The method of claim 1, wherein said profile information comprises any one or more of said user's interactions with said physical facility.

5. The method of claim 1, wherein location awareness is maintained with user permission as required.

6. The method of claim 1, wherein location awareness is maintained via geo-location of a device within said user's possession.

7. The method of claim 1, said facility comprising any of a store, a mall, a department store, a service office, an insurance or medical facility, an entertainment venue, a gym, and a movie theater.

8. The method of claim 6 wherein said device comprises any of a wireless device that can be passively interrogated or that passively identifies the user's location.

9. The method of claim 1, said user-related profile information comprising an on-line profile that is associated with the user and that contains information about any of said user's interactions with said facility across one or more said communication channels.

10. The method of claim 1, wherein said one or more facilities are part of a commerce network that provides a service to which any of said facilities and said user subscribe.

11. The method of claim 1, wherein said method comprises a service that is provided without a preexisting commitment on the part of either any of said one or more facilities or said user.

12. The method of claim 1, wherein said enhanced user experience comprises presenting sales or other opportunities to said user.

13. The method of claim 1, further comprising;
said processor finding a connection between said user's present location and said user's interactions with said facility across one or more said communication channels; and
said processor identifying stores or other such facilities at or near to said user's location that have a linking connection with said user based upon said user's interactions across one or more communication channels.

14. The method of claim 13, wherein said user is presented with a purchase related opportunity by any of a text message or a sales person who has been alerted of the user's presence at or near the facility.

15. The method of claim 1, further comprising:
said processor making use of a coincidence between said user's presence at a location and a connection between said location and said user's past interaction behavior.

16. The method of claim 1, further comprising:
said processor inking previous user interactions with a business and current location awareness to notify and/or alert said user of a location of products of interest when said user's location coincides with a physical location of said business.

17. The method of claim 16, wherein said products comprise products that said user previously searched for online but did not purchase.

18. The method of claim 1, further comprising:
said processor linking online and/or phone purchases and current location awareness of said user to offer related and/or complementary products to said user proactively when said user enters a store for in-store pickup of online purchases.

19. The method of claim 1, further comprising:
said processor automatically including relevant items not currently available in a store and proactively offering a purchase option and optimal delivery channel to said user based on said user's preferences.

20. The method of claim 1, further comprising:
said processor linking previous user interactions and/or online and/or phone purchases and current location awareness to notify and/or alert said user proactively when inventory is available in a nearby store.

21. The method of claim 1, further comprising:
said user scanning QR and/or UPC codes in a store to get product information and comparisons, and to purchase online with a mobile device, wherein said product is delivered via a preferred method comprising any of in-store pickup at a current or alternate store or shipping to a preferred address for said user.

22. The method of claim 1, further comprising:
said processor linking previous user interactions with a business and current location awareness to merge an online and/or virtual shopping cart with physical items at an in-store checkout.

23. The method of claim 1, further comprising:
said processor linking online and/or phone purchases and current location awareness to notify a store proactively of the user's proximity to initiate a picking process, wherein when said user nears said store a stock room is notified and purchased products are assembled for customer pickup.

24. An apparatus, comprising:
a processor receiving and maintaining awareness of a user's physical location and maintaining said location awareness in real time, as said user moves from location to location;
said processor configured for discovering a nexus between said user's presence within, proximity to, or movement toward one or more physical facilities outside of an explicit user transaction within any of said facilities, wherein said nexus is further discovered by said processor accessing user-related profile information and matching said user-related information to facility-related information, said nexus comprising a coincidence of said user location, said user information, said facility location, and one or more characteristics of said facility that bears a relevant connection with said user-related profile information;
said processor configured for communicating information concerning said user to one or more of said physical facilities at or near to said user's location; and
said processor configured for using a relevant connection of said user-related profile information therein to said user's physical presence at said one or more facilities and one or more characteristics of said one or more facilities to create an enhanced user experience within or in connection with said one or more facilities in real time.
